(19) United States
(12) Patent Application Publication
(10) Pub. No.: US 2026/0211179 A1
(43) Pub. Date: Jul. 23, 2026

(54) PHOTONIC STRUCTURE AND METHODS OF MANUFACTURING THE SAME

(71) Applicant: TAIWAN SEMICONDUCTOR MANUFACTURING COMPANY LTD., HSINCHU (TW)

(72) Inventors: CHIA-WEI CHIANG, HSINCHU COUNTY (TW); SHENG KAI YEH, TAICHUNG CITY (TW); LIAN WEE LUO, HSINCHU (TW); CHI-YUAN SHIH, HSINCHU (TW); CHUN-PEI WU, NANTOU COUNTY (TW); TSE-EN CHANG, HSINCHU CITY (TW)

(21) Appl. No.: 19/033,699

(22) Filed: Jan. 22, 2025

(51) Int. Cl. G02B 6/122; G02B 6/13

(52) U.S. Cl. CPC G02B 6/122; G02B 6/13

(57) ABSTRACT

A photonic structure is provided. The photonic structure includes an optical coupling structure. The optical coupling structure includes a central portion including a first waveguide region and a second waveguide region, a first slab region, a second slab region, a first electrical coupling region and a second electrical coupling region, which are strips parallel to each other. The first slab region and the first electrical coupling region have first dopants with a first conductivity type, and the second slab region and the second electrical coupling region have second dopants with a second conductivity type. At least one of the first waveguide region and the second waveguide region includes two portions having dopants with different conductivity types.

### BACKGROUND

Silicon photonic devices can be made using existing semiconductor fabrication techniques, and because silicon is already used as the substrate for most integrated circuits, it is possible to create hybrid devices in which the optical and electronic components are integrated onto a single microchip. Consequently, silicon photonics is being actively researched by many electronics manufacturers, as well as by academic research groups, as a means for keeping on track with Moore's Law, by using optical interconnects to provide faster data transfer both between and within microchips.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 illustrates a top view of a photonic structure, in accordance with some embodiments of the present disclosure.

FIGS. 2 to 8 illustrate cross-sectional front views along line A-A′ of the photonic structure shown in FIG. 1, in accordance with some embodiments of the present disclosure.

FIG. 9 illustrates a top view of a photonic structure, in accordance with some another embodiments of the present disclosure.

FIGS. 10 to 13 illustrate cross-sectional side views along line B-B′ of the photonic structure shown in FIG. 9, in accordance with various embodiments of the present disclosure.

FIGS. 14A and 14B illustrate top views of a photonic structure, in accordance with some another embodiments of the present disclosure.

FIGS. 15 to 18 illustrate cross-sectional side views along line C-C′ of the photonic structure shown in FIGS. 14A and 14B, in accordance with various embodiments of the present disclosure.

FIG. 19 is a flowchart of a method for forming the photonic structure in accordance with some embodiments.

FIGS. 20A to 20E illustrate various cross-sectional views along line A′-A′ of the photonic structure shown in FIG. 1 of forming the photonic structure in accordance with some embodiments as described in FIG. 19.

FIG. 21 is a flowchart of a method for forming the photonic structure in accordance with some another embodiments.

FIGS. 22A to 22H illustrate various cross-sectional views along line B′-B′ of the photonic structure shown in FIG. 9 of forming the photonic structure in accordance with some embodiments as described in FIG. 21.

### DETAILED DESCRIPTION OF THE DISCLOSURE

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 100 degrees or at other orientations) and the spatially relative descriptors used herein may likewise be interpreted accordingly.

As used herein, the terms such as “first,” “second” and “third” describe various elements, components, regions, layers and/or sections, but these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

The present disclosure relates to photonic devices which are made up of different layers. When the terms “on” or “upon” are used with reference to two different layers (including the substrate), they indicate merely that one layer is on or upon the other layer and do not require the two layers to directly contact each other, and permit other layers to be between the two layers. For example, all layers of the photonic device can be considered to be “on” the substrate, even though they do not all directly contact the substrate. The term “directly” may be used to indicate two layers directly contact each other without any layers in between them.

Photonic structure is a promising platform for the construction of efficient information processing chips due to its compatibility to complementary-metal-oxide semiconductor (CMOS) technology, and with benefits of low cost, and high yield. A photodetector can be used in a photonic structure to detect optical signals. Photodetectors include vertical PN junction photodiodes and lateral PN junction photodiodes. In a vertical PN junction photodiode, P-type and N-type semiconductor layers are stacked vertically. In a lateral PN junction photodiode, P-type and N-type materials are formed side-by-side on a same plane. For a typical vertical PN junction photodiodes, despite their ease of fabrication, are hindered by a screening effect under intense illumination, leading to reduced efficiency. This effect occurs when charge carriers recombine at the surface, preventing them from contributing to the photocurrent. Lateral PN junctions, arranged side-by-side, offer improvement in reducing surface recombination but fall short in bandwidth, which is critical for high-speed applications. Both types of photodiodes struggle to balance high responsivity with wide bandwidth, a trade-off that limiting their performance in demanding scenarios involving high photocurrents and laser power. A photodiode that can deliver both high-speed response and high efficiency, even in high-power conditions is desired.

In addition, to decrease parasitic resistance of a photodetector, a thicker slab may be used, or heavier implant dose may be applied to form the PN junction. However, a thicker slab can lead to poor optical mode confinement in an optical coupling structure, which may result in optical loss. A heavier implant dose may result in a higher dopant concentration within an optical coupling structure, leading to increased free carrier absorption, consequently resulting in high optical loss. There is a need to obtain a photodetector with enhanced performance and low optical loss.

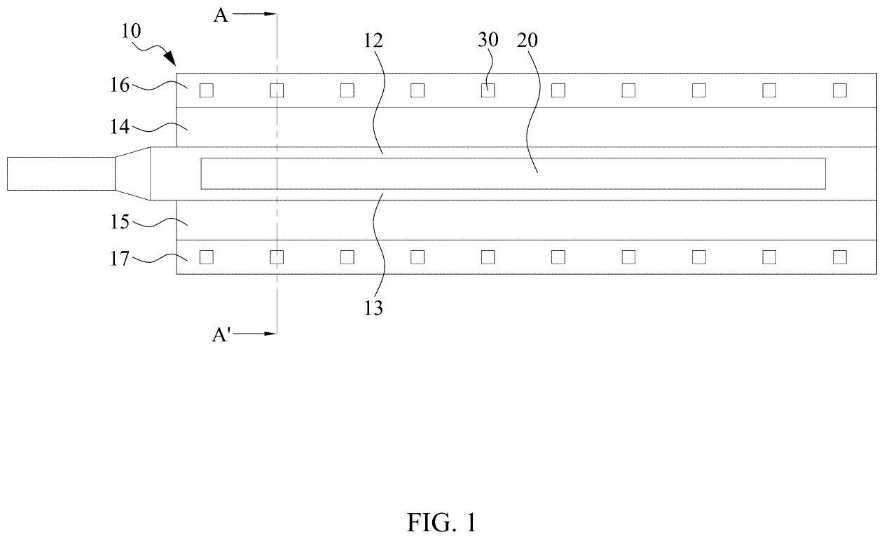

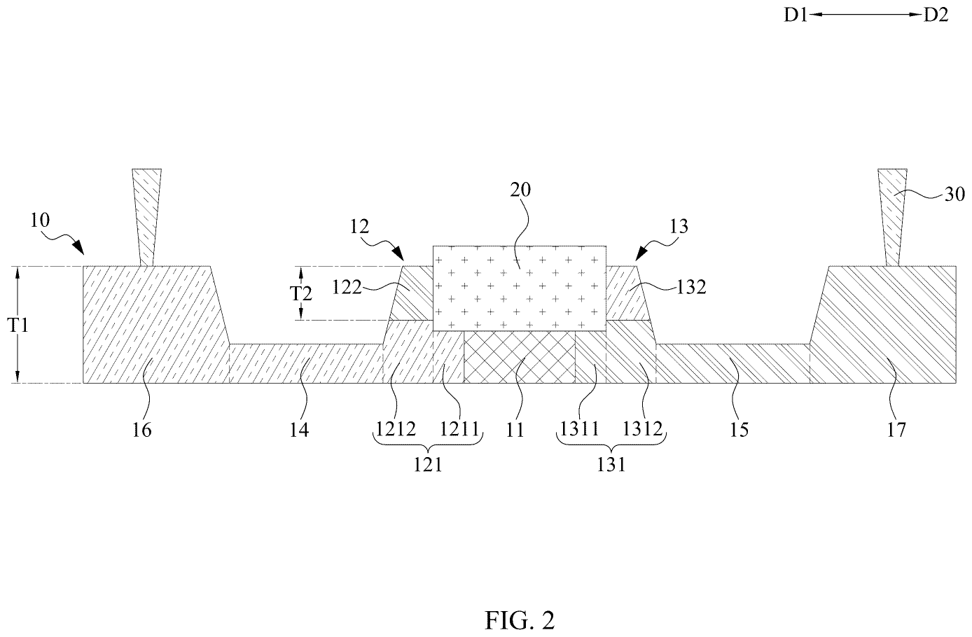

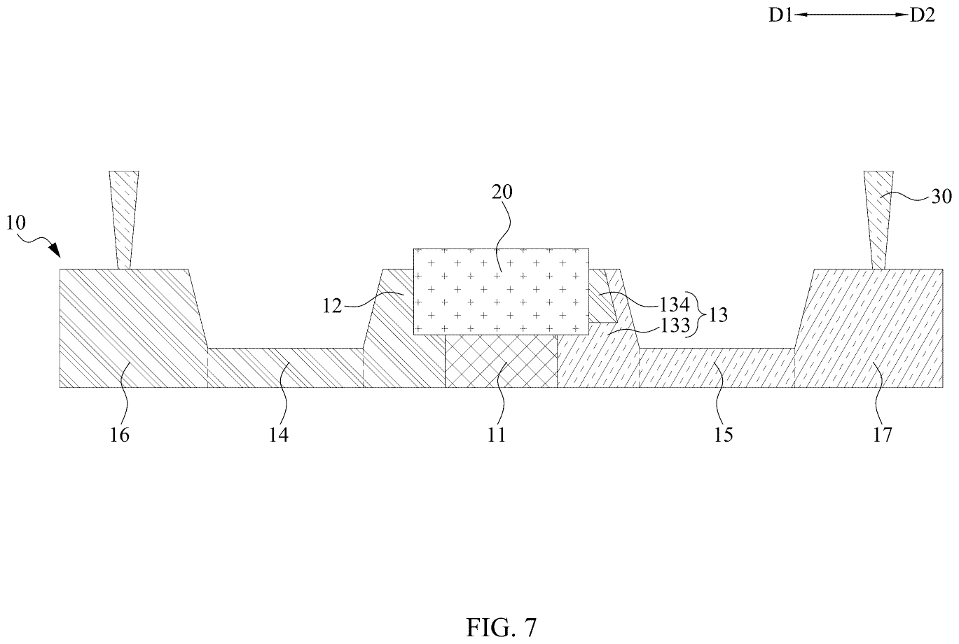

FIG. 1 illustrates a top view of a photonic structure in accordance with some embodiments of the present disclosure and FIGS. 2 to 8 illustrate cross-sectional front views along line A-A′ of the photonic structure shown in FIG. 1. The photonic structure comprises an optical coupling structure 10, a photodetector 20 and contacts 30.

The optical coupling structure 10 is formed on a base layer including a substrate with a cladding layer (not shown). The substrate can be a wafer made of a semiconducting material. Such materials can include silicon, for example in the form of monocrystalline Si or polycrystalline Si. The substrate can also be made from other elementary semiconductors such as germanium or Al₂O₃ (sapphire), or may include a compound semiconductor such as silicon carbide (SiC), gallium nitride (GaN), gallium arsenide (GaAs), indium arsenide (InAs), and indium phosphide (InP), or from other materials such as glass, a ceramic, or a dielectric material. In some embodiments, the substrate may be a silicon-on-insulator (SOI) wafer. An SOI wafer comprises a substrate and an insulating layer (e.g., buried oxide or BOX) formed on the substrate. The cladding layer is overlaid onto the substrate and may include a dielectric material, such as silicon oxide. The material forming the cladding layer may be identical to that forming the buried oxide of the insulating layer of the SOI wafer. In some embodiments, the cladding layer may include oxide and serve as the buried oxide of the insulating layer of the SOI wafer.

The optical coupling structure 10 comprises a base region 11, a first waveguide region 12, a second waveguide region 13, a first slab region 14, a second slab region 15, a first electrical coupling region 16 and a second electrical coupling region 17. In some embodiments, the base region 11, the first waveguide region 12 and the second waveguide region 13 constitute a waveguide of the optical coupling structure 10. The base region 11, the first waveguide region 12, the second waveguide region 13, the first slab region 14, the second slab region 15, the first electrical coupling region 16 and the second electrical coupling region 17 are strips parallel to each other. The base region 11 is sandwiched by the first waveguide region 12 and the second waveguide region 13. The first waveguide region 12 extends from the base region 11 along a first direction D1. The first slab region 14 is adjacent to the first waveguide region 12 and extends from the first waveguide region 12 along the first direction D1. The first electrical coupling region 16 is adjacent to the first slab region 14 and extends from the first slab region 14 along the first direction D1, so that the first waveguide region 12 is sandwiched by the base region 11 and the first slab region 14, and the first slab region 14 is sandwiched by the first waveguide region 12 and the first electrical coupling region 16. The second waveguide region 13 extends from the base region 11 along a second direction D2 opposite to the first direction D1. The second slab region 15 is adjacent to the second waveguide region 13 and extends from the second waveguide region 13 along the second direction D2. The second electrical coupling region 17 is adjacent to the second slab region 15 and extends from the second slab region 15 along the second direction D2, so that the second waveguide region 13 is sandwiched by the base region 11 and the second slab region 15, and the second slab region 15 is sandwiched by the second waveguide region 13 and the second electrical coupling region 17.

A thickness of the first waveguide region 12 and a thickness of the second waveguide region 13 may be substantially identical or different from each other. In some embodiments as shown in FIG. 2, the thickness of the first waveguide region 12 can be substantially identical to the thickness of the second waveguide region 13, so that a top of the first waveguide region 12 and a top of the second waveguide region 13 can be substantially coplanar. A thickness of the first slab region 14 and a thickness of the second slab region 15 may be substantially identical or different from each other. In some embodiments as shown in FIG. 2, the thickness of the first slab region 14 can be substantially identical to the thickness of the second slab region 15, so that a top of the first slab region 14 and a top of the second slab region 15 can be substantially coplanar. A thickness of the first electrical coupling region 16 and a thickness of the second electrical coupling region 17 may be substantially identical or different from each other. In some embodiments as shown in FIG. 2, the thickness of the first electrical coupling region 16 can be substantially identical to the thickness of the thickness of the second electrical coupling region 17, so that a top of the first electrical coupling region 16 and a top of the second electrical coupling region 17 can be substantially coplanar.

The thickness of the first waveguide region 12 may be substantially identical to the thickness of the first electrical coupling region 16, may be greater than a thickness of the base region 11, and/or may be greater than a thickness of the first slab region 14. The thickness of the second waveguide region 13 may be substantially identical to the thickness of the second electrical coupling region 17, may be greater than a thickness of the base region 11, and/or may be greater than a thickness of the second slab region 15. The thickness of the base region 11 may be greater than the thickness of the first slab region 14 and may be greater than the thickness of the second slab region 15.

The first slab region 14 and the first electrical coupling region 16 comprise first dopants with a first conductivity type. The second slab region 15 and the second electrical coupling region 17 have second dopants with a second conductivity type. In some embodiments, the base region 11 may also comprise a first base region and a second base region comprising dopants with different conductive types. When the first conductivity type is n type, the second conductivity type is p type; and when the first conductivity type is p type, the second conductivity type is n type. Any suitable P-type dopant may be used, such as one or more of boron (B), gallium (Ga), or indium (In), any suitable N-type dopant may be used, such as one or more of phosphorous (P), arsenic (As), antimony (Sb), bismuth (Bi), lithium (Li), etc. In some embodiments, the P-type doping concentration may range from about 1E16 atom/cm³ to about 1E21 atom/cm³ and the N-type doping concentration may range from about 1E16 atom/cm³ to about 1E21 atom/cm³.

The photodetector 20 is formed on the base region 11 and is sandwiched by the first waveguide region 12 and the second waveguide region 13. The photodetector 20 has two side surfaces abutting the first waveguide region 12. The photodetector 20 may comprise germanium (Ge).

The contacts 30 are formed on the first electrical coupling region 16 and on the second electrical coupling region 17.

Referring to FIG. 2, the first waveguide region 12 comprises a bottom portion 121 and a top portion 122. The bottom portion 121 of the first waveguide region 12 and the top portion 122 of the first waveguide region 12 comprise dopants with different conductivity types. For example, as shown in FIG. 2, the bottom portion 121 of the first waveguide region 12 comprises the first dopants and the top portion 122 of the first waveguide region 12 comprises the second dopants. The top portion 122 of the first waveguide region 12 has a thickness T2, which may be greater than, equal to or less than a thickness of the bottom portion 121 of the first waveguide region 12. In some embodiments, a ratio of the thickness T2 of the bottom portion 121 of the first waveguide region 12 to the thickness T1 of the first waveguide region 12 (i.e., sum of the thickness of the bottom portion 121 and the thickness T2 of the top portion 122 of the first waveguide region 12) may range from about 0.1:1 to about 0.9:1. In some embodiments, the ratio of the thickness T2 of the bottom portion 121 of the first waveguide region 12 to the thickness T1 of the first waveguide region 12 may range from about 0.2:1 to about 0.8:1. In some embodiments, the ratio of the thickness T2 of the bottom portion 121 of the first waveguide region 12 to the thickness T1 of the first waveguide region 12 may range from about 0.3:1 to about 0.7:1. In some embodiments, an interface of the bottom portion 121 and the top portion 122 may be substantially aligned with a bottom of the photodetector 20. In some another embodiments, the interface of the bottom portion 121 and the top portion 122 may be lower than the bottom of the photodetector 20 and abutting the base region 11 of the optical coupling structure 10. In some embodiments, the interface of the bottom portion 121 and the top portion 122 may be higher than the bottom of the photodetector 20 and abutting the photodetector 20.

The second waveguide region 13 comprises a bottom portion 131 and a top portion 132. The bottom portion 131 of the second waveguide region 13 and the top portion 132 of the second waveguide region 13 comprise dopants with different conductivity types. For example, as shown in FIG. 2, the bottom portion 131 of the second waveguide region 13 comprises the second dopants and the top portion 132 of the second waveguide region 13 comprises the first dopants. The top portion 132 of the second waveguide region 13 has a thickness, which may be greater than, equal to or less than a thickness of the bottom portion 131 of the second waveguide region 13. In some embodiments, a ratio of the thickness of the bottom portion 131 of the second waveguide region 13 to the thickness of the second waveguide region 13 (i.e., sum of the thickness of the bottom portion 131 and the thickness of the top portion 132 of the second waveguide region 13) may range from about 0.1:1 to about 0.9:1. In some embodiments, the ratio of the thickness of the bottom portion 131 of the second waveguide region 13 to the thickness of the second waveguide region 13 may range from about 0.2:1 to about 0.8:1. In some embodiments, the ratio of the thickness of the bottom portion 131 of the second waveguide region 13 to the thickness of the second waveguide region 13 may range from about 0.3:1 to about 0.7:1.

The bottom portion 121 of the first waveguide region 12 includes an inner area 1211 and an outer area 1212. The inner area 1211 of the bottom portion 121 of the first waveguide region 12 abuts the base region 11 and may have a thickness substantially identical to the thickness of the base region 11. The outer area 1212 of the bottom portion 121 of the first waveguide region 12 is sandwiched by the inner area 1211 of the bottom portion 121 of the first waveguide region 12 and the first slab region 14. A thickness of the inner area 1211 of the bottom portion 121 of the first waveguide region 12 is greater than the thickness of the inner area 1211 of the bottom portion 121 of the first waveguide region 12. The top portion 122 of the first waveguide region 12 is located on the outer area 1212 of the bottom portion 121 of the first waveguide region 12. The bottom portion 131 of the second waveguide region 13 includes an inner area 1311 and an outer area 1312. The inner area 1311 of the bottom portion 131 of the second waveguide region 13 abuts the base region 11 and may have a thickness substantially identical to the thickness of the base region 11. The outer area 1312 of the bottom portion 131 of the second waveguide region 13 is sandwiched by the inner area 1311 of the bottom portion 131 of the second waveguide region 13 and the second slab region 15. A thickness of the inner area 1311 of the bottom portion 131 of the second waveguide region 13 is greater than the thickness of the inner area 1311 of the bottom portion 131 of the second waveguide region 13. The top portion 132 of the second waveguide region 13 is located on the outer area 1312 of the bottom portion 131 of the second waveguide region 13. The photodetector 20 is formed on the base region 11 and also on the inner areas 1211, 1311 of the bottom portions 121, 131 of the first waveguide region 12 and the second waveguide region 13. The top portion 122 of the first waveguide region 12 and the top portion 132 of the second waveguide region 13 abut the two sides of the photodetector 20. The outer areas 1212, 1312 of the bottom portions 121, 131 of the first waveguide region 12 and the second waveguide region 13 partially abut the two sides of the photodetector 20, respectively.

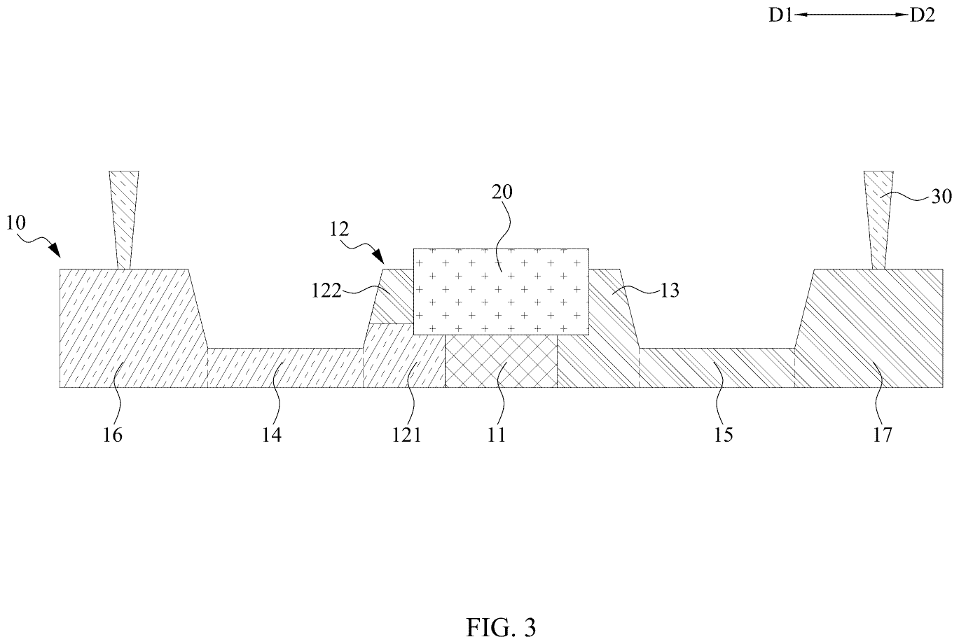

The optical coupling structure 10 illustrated in FIG. 3 is similar to that illustrated in FIG. 2. In the optical coupling structure 10 illustrated in FIG. 3, the first waveguide region 12 comprises a bottom portion 121 comprising the first dopants and a top portion 122 comprising the second dopants while the second waveguide region 13 comprises the second dopants without including the first dopants.

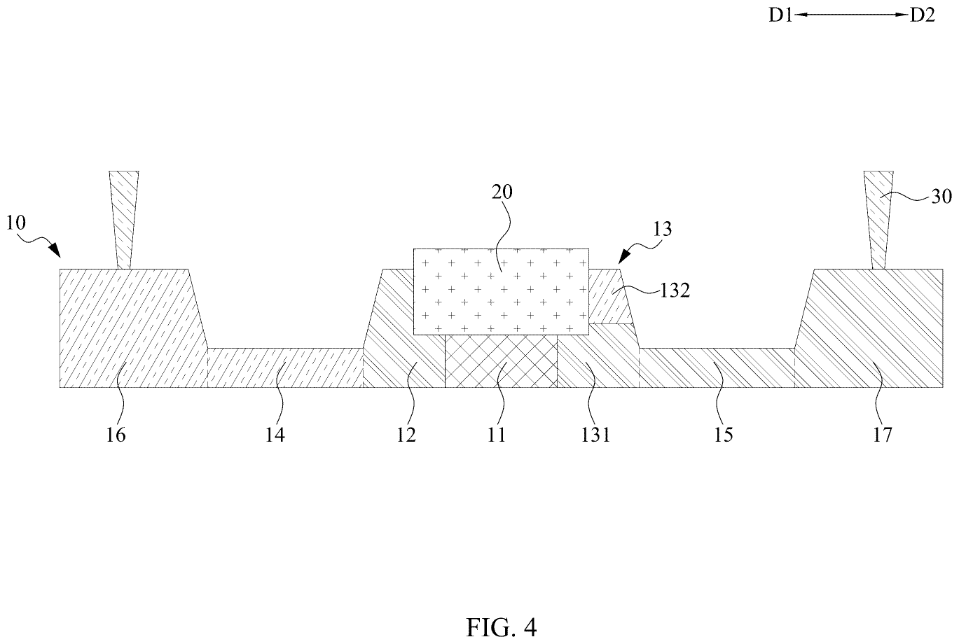

The optical coupling structure 10 illustrated in FIG. 4 is similar to that illustrated in FIG. 2. In the optical coupling structure 10 illustrated in FIG. 4, the first waveguide region 12 comprises the second dopants without including the first dopants while the second waveguide region 13 comprises a bottom portion 131 comprising the second dopants and a top portion 132 comprising the first dopants. Therefore, the dopants in the first waveguide region 12 is different in conductive type from those in the first slab region 14 and the first electrical coupling region 16, and identical to those in the bottom portion 131 of the second waveguide region 13.

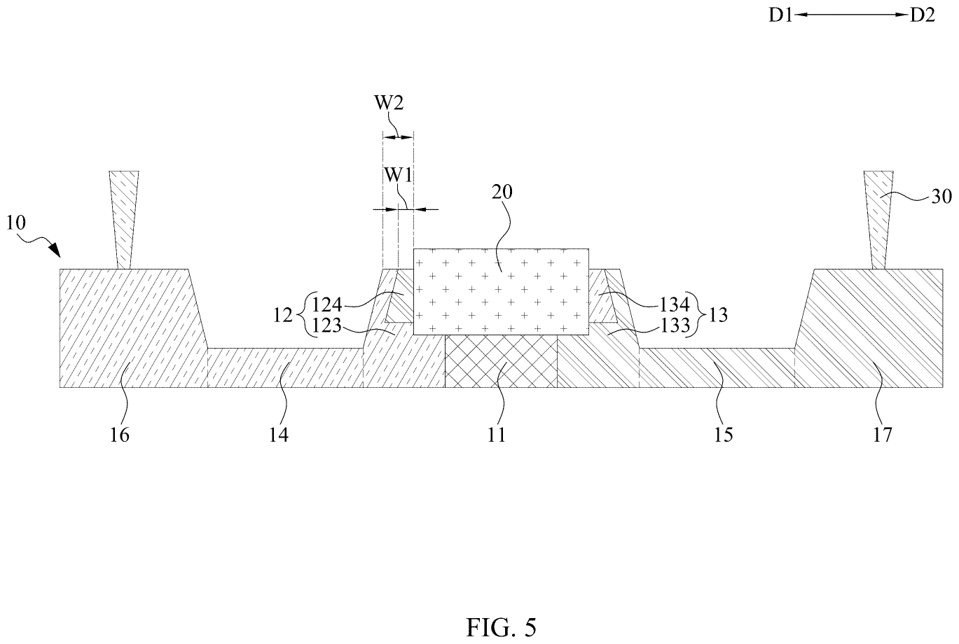

Referring to FIG. 5, the first waveguide region 12 comprises an outer portion 123 comprising the first dopants and an inner portion 124 comprising the second dopants. The inner portion 124 is surrounded by the outer portion 123 and the photodetector 20 to expose a top of the inner portion 124. The thickness of the photodetector 20 is greater than a thickness of the inner portion 124, so a bottom of the photodetector 20 is lower than a bottom of the inner portion 124 and a top of the photodetector 20 is higher than a bottom of the inner portion 124. The second waveguide region 13 comprises an outer portion 133 comprising the first dopants and an inner portion 134 comprising the second dopants. The inner portion 134 is surrounded by the outer portion 133 and the photodetector 20 to expose a top of the inner portion 134. The thickness of the photodetector 20 may be greater than a thickness of the inner portion 134, so the bottom of the photodetector 20 may be lower than a bottom of the inner portion 134 and the top of the photodetector 20 may be higher than a bottom of the inner portion 134. Therefore, the configuration of the first waveguide region 12 mirrors that of the second waveguide region 13.

In some embodiments, a ratio of a width of the top of the inner portion 124 to a width of the top of the first waveguide region 12 may range from about 0.1:1 to about 0.9:1. In some embodiments, a ratio of a width of the top of the inner portion 124 to a width of the top of the first waveguide region 12 may range from about 0.2:1 to about 0.8:1. In some embodiments, a ratio of a width of the top of the inner portion 124 to a width of the top of the first waveguide region 12 may range from about 0.3:1 to about 0.7:1. In some embodiments, a ratio of a width of the top of the inner portion 134 to a width of the top of the second waveguide region 13 may range from about 0.1:1 to about 0.9:1. In some embodiments, a ratio of a width of the top of the inner portion 134 to a width of the top of the second waveguide region 13 may range from about 0.2:1 to about 0.8:1. In some embodiments, a ratio of a width of the top of the inner portion 134 to a width of the top of the second waveguide region 13 may range from about 0.3:1 to about 0.7:1.

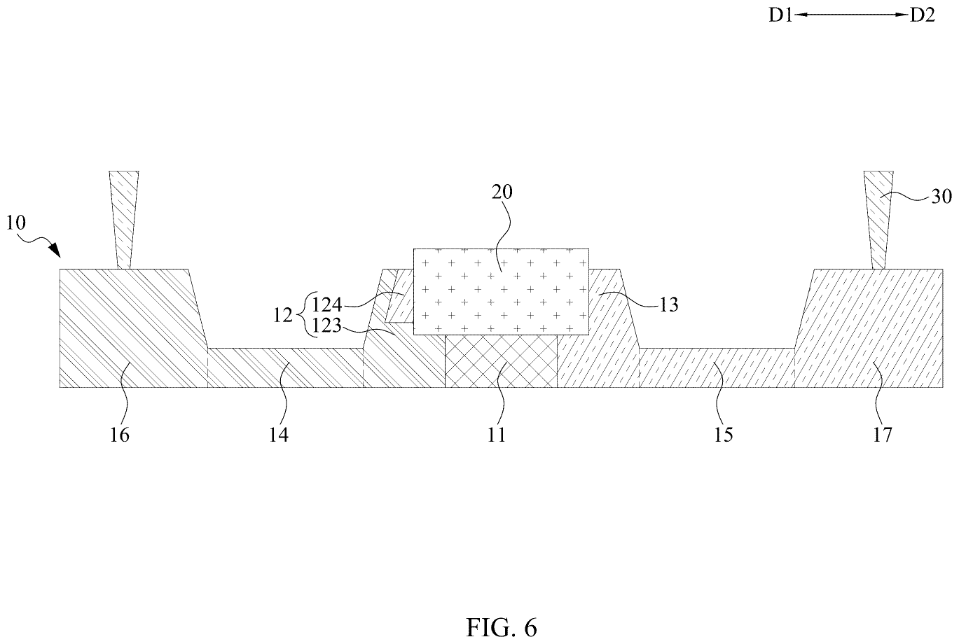

The optical coupling structure 10 illustrated in FIG. 6 is similar to that illustrated in FIG. 5. In the optical coupling structure 10 illustrated in FIG. 6, the first waveguide region 12 comprises an outer portion 123 comprising the first dopants and an inner portion 124 comprising the second dopants while the second waveguide region 13 comprises the second dopants without including the first dopants.

The optical coupling structure 10 illustrated in FIG. 6 is similar to that illustrated in FIG. 5. In the optical coupling structure 10 illustrated in FIG. 6, the first waveguide region 12 comprises the first dopants without including the second dopants while the second waveguide region 13 comprises an outer portion 133 comprising the first dopants and an inner portion 134 comprising the second dopants.

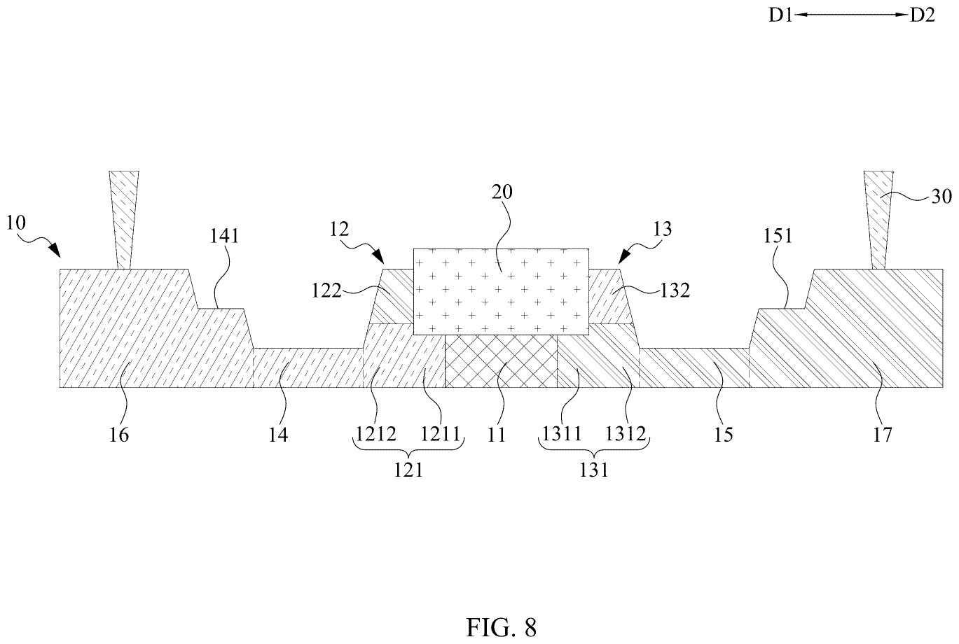

The optical coupling structure 10 illustrated in FIG. 8 is similar to that illustrated in FIG. 2. In the optical coupling structure 10 illustrated in FIG. 8, the first slab region 14 has a stepwise top 141, so that the thickness of the first slab region 14 can be stepwisely decreased from an area near the first electrical coupling region 16 to an area near the first waveguide region 12 (along the second direction D2); and the second slab region 15 has a stepwise top 151, so that the thickness of the second slab region 15 can be stepwisely decreased from an area near the second electrical coupling region 17 to an area near the second waveguide region 13 (along the first direction D1). In addition, each of the first slab region 14 and the second slab region 15 may have a slope top sliding from areas near the first and second electrical coupling regions 16 and 17 toward the base region 11. Such configuration may also applied to the embodiments illustrated in FIGS. 3 to 7.

The hybrid junction design of the photonic structure in accordance with the present disclosure combines benefits of vertical PN junction photodiodes and lateral PN junction photodiodes. Such photonic structure is engineered to minimize the screening effect, which leads to enhanced efficiency under high illumination conditions. Meanwhile, due to the layout and geometry of the optical coupling structure, a superior balance of high responsivity and wide bandwidth can be achieved. Further, the photonic structure in accordance with the present disclosure can maintain performance under extreme conditions, such as high photocurrents and laser power.

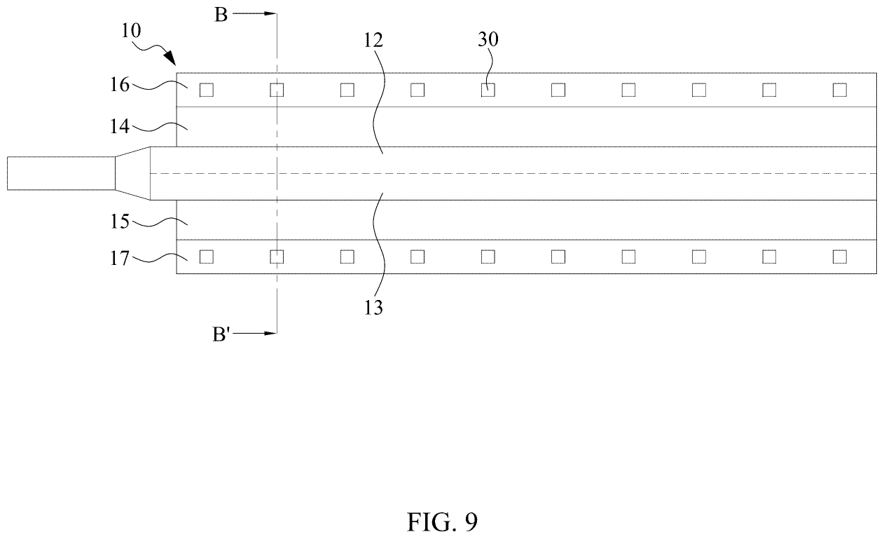

In some embodiments, the photodetector 20 may be absent from a photonic structure in accordance with some another embodiments of the present disclosure as shown in FIG. 9, and thus the photonic structure comprises an optical coupling structure 10 and a photodetector 20.

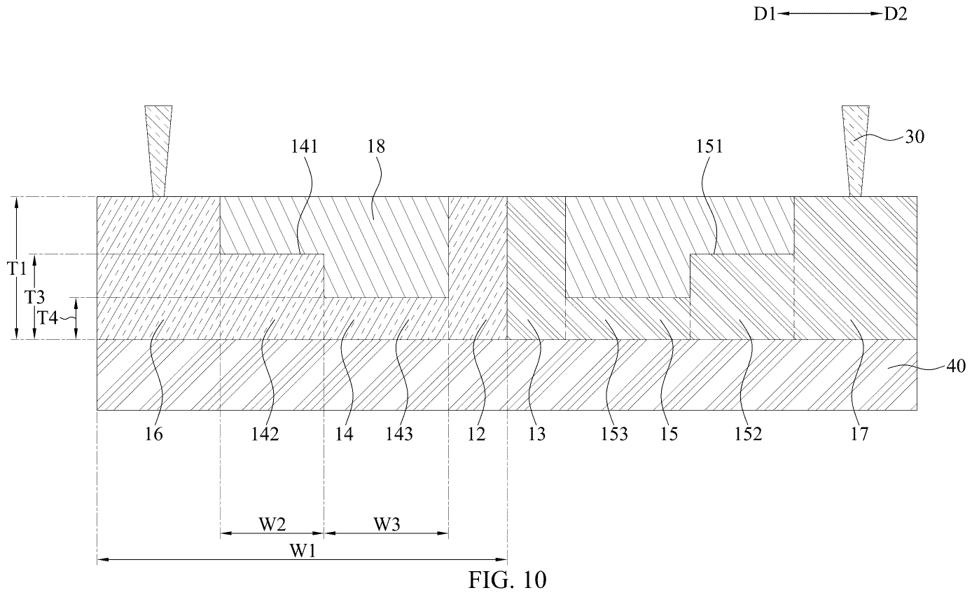

With reference to FIGS. 9 and 10, the optical coupling structure 10 is formed on a substrate with a base layer 40 including a substrate with a cladding layer, which are described above. The optical coupling structure 10 comprises a first waveguide region 12, a second waveguide region 13, a first slab region 14, a second slab region 15, a first electrical coupling region 16 and a second electrical coupling region 17. The second base region 112, the first waveguide region 12, the second waveguide region 13, the first slab region 14, the second slab region 15, the first electrical coupling region 16 and the second electrical coupling region 17 are strips parallel to each other. The first waveguide region 12 and the second waveguide region 13 abut to each other. The first slab region 14 is adjacent to the first waveguide region 12 and extends from the first waveguide region 12 along the first direction D1. The first electrical coupling region 16 is adjacent to the first slab region 14 and extends from the first slab region 14 along the first direction D1, so that the first waveguide region 12 is sandwiched by the first base region 111 and the first slab region 14, and the first slab region 14 is sandwiched by the first waveguide region 12 and the first electrical coupling region 16. The second slab region 15 is adjacent to the second waveguide region 13 and extends from the second waveguide region 13 along the second direction D2. The second electrical coupling region 17 is adjacent to the second slab region 15 and extends from the second slab region 15 along the second direction D2, so that the second waveguide region 13 is sandwiched by the base region 11 and the second slab region 15, and the second slab region 15 is sandwiched by the second waveguide region 13 and the second electrical coupling region 17. Shallow trench isolation (STI) structures 18 may be formed onto the first slab region 14 and the second slab region 15 and thus formed between the first waveguide region 12 and the first electrical coupling region 16 and between the second waveguide region 13 and the second electrical coupling region 17. Tops of the STI structures may be substantially coplanar with a top of the first waveguide region 12 and a top of the second waveguide region 13; and may be substantially coplanar with a top of the first electrical coupling region 16 and a top of the second electrical coupling region 17.

A thickness of the first waveguide region 12 and a thickness of the second waveguide region 13 may be substantially identical or different from each other. In some embodiments as shown in FIG. 10, the thickness of the first waveguide region 12 can be substantially identical to the thickness of the second waveguide region 13, so that the top of the first waveguide region 12 and the top of the second waveguide region 13 can be substantially coplanar. A thickness of the first electrical coupling region 16 and a thickness of the second electrical coupling region 17 may be substantially identical or different from each other. In some embodiments as shown in FIG. 10, the thickness of the first electrical coupling region 16 can be substantially identical to the thickness of the thickness of the second electrical coupling region 17, so that the top of the first electrical coupling region 16 and the top of the second electrical coupling region 17 can be substantially coplanar.

The contacts 30 are formed on the first electrical coupling region 16 and on the second electrical coupling region 17.

Referring to FIG. 10, the first slab region 14 has a stepwise top 141, so that the thickness of the first slab region 14 can be stepwisely decreased from an area near the first electrical coupling region 16 to an area near the first waveguide region 12 (along the second direction D2); and the second slab region 15 has a stepwise top 151, so that the thickness of the second slab region 15 can be stepwisely decreased from an area near the second electrical coupling region 17 to an area near the second waveguide region 13 (along the first direction D1). As shown in FIG. 10, the first slab region 14 comprises a first step portion 142 abutting the first electrical coupling region 16 and a second step portion 143 abutting the first waveguide region 12. A width W1 of the first step portion 142 and a width W2 of the second step portion 143 may be substantially identical or different from each other. In some embodiments as shown in FIG. 10, the width W1 of the first step portion 142 and the width W2 of the second step portion 143 are substantially identical to each other. In some embodiments, a ratio of the width W1 of the first step portion 142 to a total width W1 of a width of the first waveguide region 12, a width of the first slab region 14 and a width of the first electrical coupling region 16 may range from about 2:5 to about 0.1:5. In some embodiments, the ratio of the width W2 of the first step portion 142 to the total width W1 may range from about 1:3 to about 0.1:3. In some embodiments, a ratio of the width W2 of the second step portion 143 to the total width W1 may range from about 2:5 to about 0.1:5. In some embodiments, the ratio of the width W2 of the first step portion 142 to the total width W1 may range from about 1:3 to about 0.1:3.

The thickness T1 of the first electrical coupling region 16 can be greater than a thickness T3 of the first step portion 142; and the thickness T3 of the first step portion 142 can be greater than a thickness T4 of the second step portion 143. In some embodiments, a ratio of the thickness T3 of the first step portion 142 to the thickness T1 of the first electrical coupling region 16 may range from about 1:2 to about 1:50. In some embodiments, the ratio of the thickness T3 of the first step portion 142 to the thickness T1 of the first electrical coupling region 16 may range from about 1:3 to about 1:40. In some embodiments, a ratio of the thickness T4 of the second step portion 143 to the thickness T1 of the first electrical coupling region 16 may range from about 1:3 to about 1:50. In some embodiments, the ratio of the thickness T4 of the second step portion 143 to the thickness T1 of the first electrical coupling region 16 may range from about 1:5 to about 1:40. The configuration of the second slab region 15 can mirror that of the first slab region 14, so the second slab region 15 comprises a first step portion 152 corresponding to the first step portion 142 of the first slab region 14 and a second step portion 153 corresponding to the second step portion 143 of the first slab region 14.

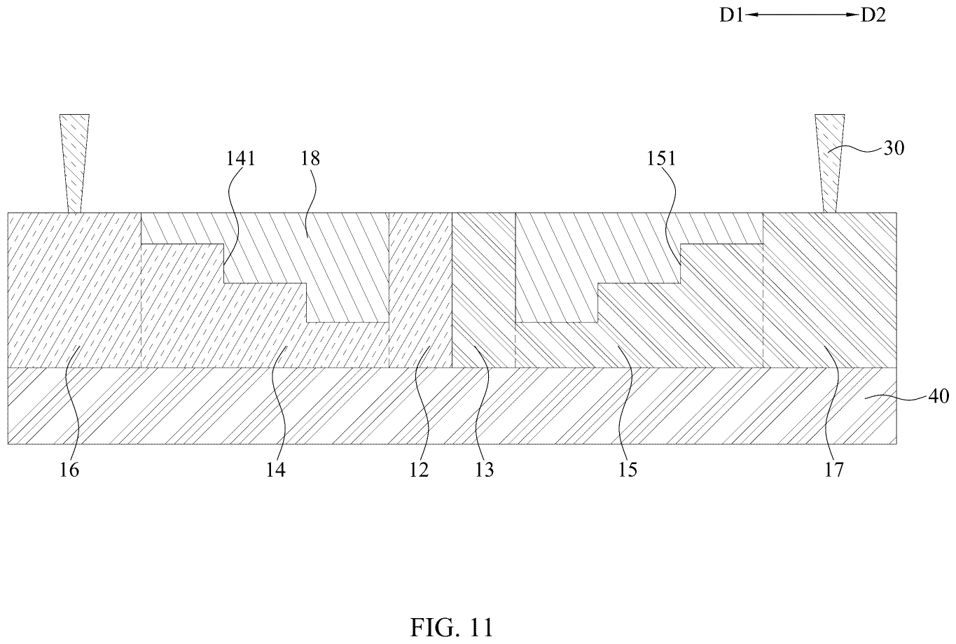

The first slab region 14 may comprise two or more step portions and the second electrical coupling region may comprise two or more step portions. The number of step portions of the first slab region 14 may be identical to or different from that of the second slab region 15. As shown in FIG. 11, the first slab region 14 comprises three step portions and the second electrical coupling region also comprises three step portions. In addition, each of the first slab region 14 and the second slab region 15 may have a slope top sliding from areas near the first and second electrical coupling regions 16 and 17 toward the first waveguide region 12 and the second waveguide region 13.

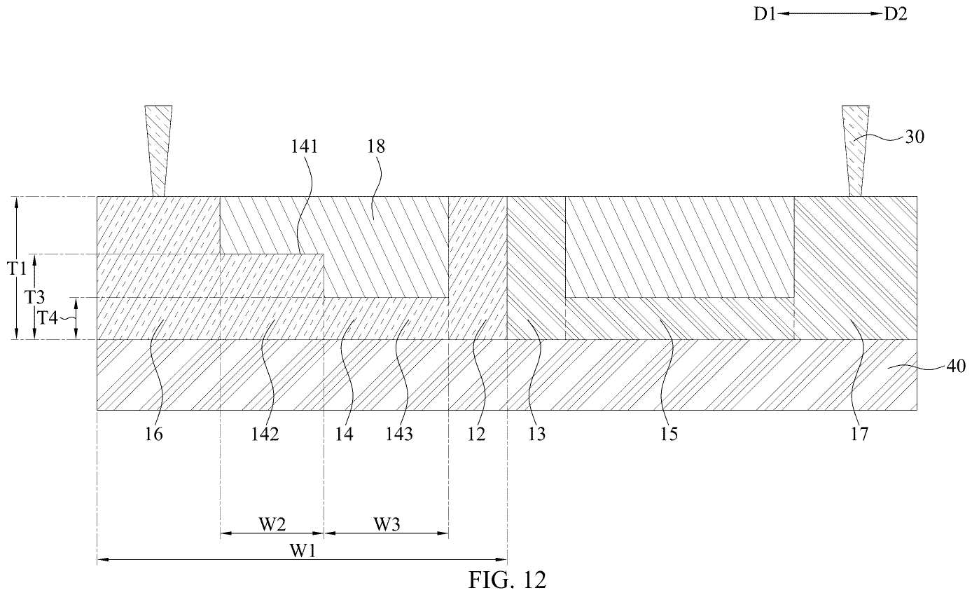

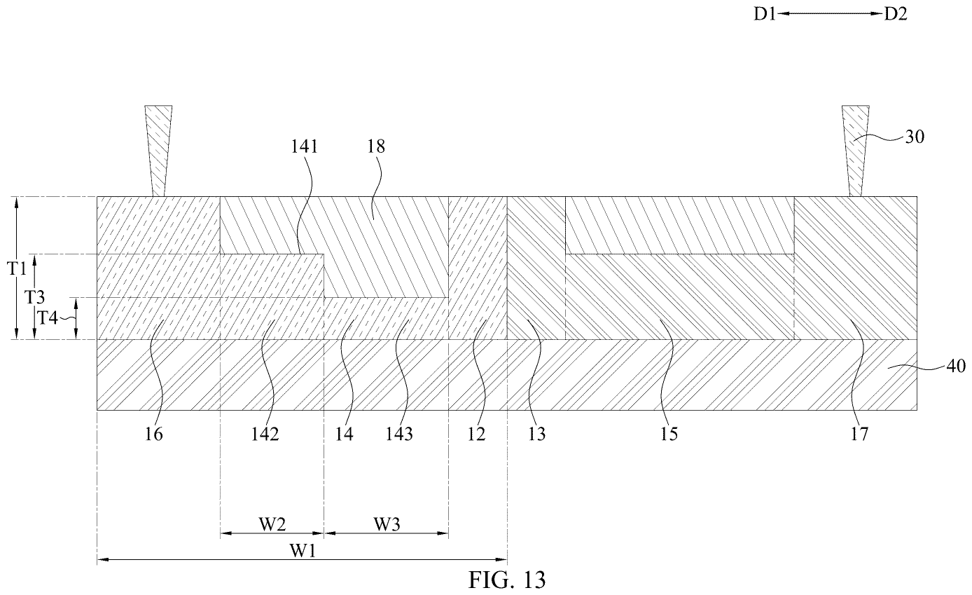

In some embodiments as shown in FIG. 12, the first slab region 14 comprises a first step portion 142 and a second step portion 143 while the second slab region 15 has a substantially flat top. The thickness of the second slab region 15 may be substantially identical to the thickness T4 of the second step portion 143. In some alternative embodiments as shown in FIG. 13, the thickness of the second slab region 15 may be substantially identical to the thickness T3 of the first step portion 142. The configuration of the first slab region 14 may be symmetric or asymmetric with that of the second slab region 15.

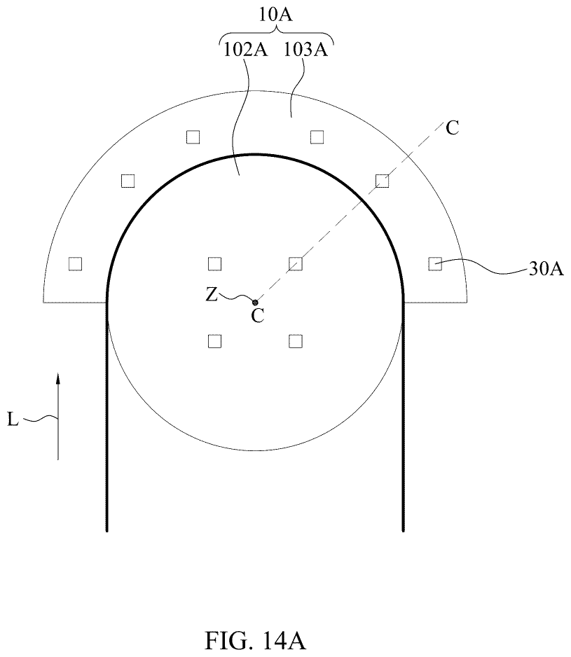

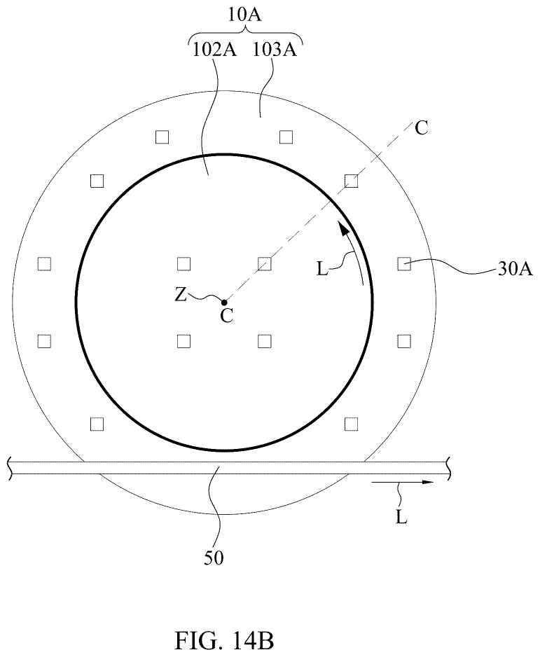

Such configuration of the first and second slab region 14, 15 may be also applied to an optical coupling structure with a bent waveguide, such as a ring resonator. As shown in FIGS. 14A and 14B, the photonic structure comprises an optical coupling structure 10A with a bent waveguide and contacts 30A. The optical coupling structure 10A comprises an outer region 101A and an inner region 102A with a rotation center Z, so that an optical mode OP may move toward to the outer region 101A. The outer region 101A comprises first dopants with a first conductivity type and the inner region 102A have second dopants with a second conductivity type. In the photonic structure shown in FIG. 14B, a bus waveguide 50 can be used along with the disk-like optical coupling structure 10A. Light beam L propagates along a direction indicated by arrows.

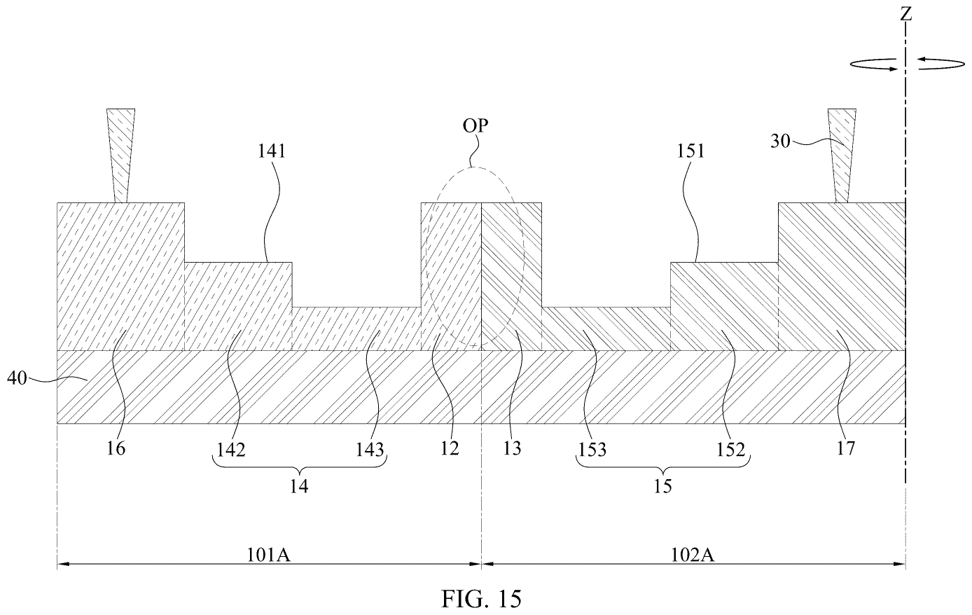

With further reference to FIG. 15, the outer region 101A comprises a first waveguide region 12, a first slab region 14 and a first electrical coupling region 16, and the inner region 102A comprises a second waveguide region 13, a second slab region 15 and a second electrical coupling region 17. The configuration of the first waveguide region 12, the second waveguide region 13, the first slab region 14, the second slab region 15, the first electrical coupling region 16 and the second electrical coupling region 17 are similar to that shown in FIG. 10. It should be noted that similar elements in FIGS. 15 to 18 and FIGS. 10-13 are designated by the same numerals, and can include similar materials, therefore those details are omitted in the interest of brevity.

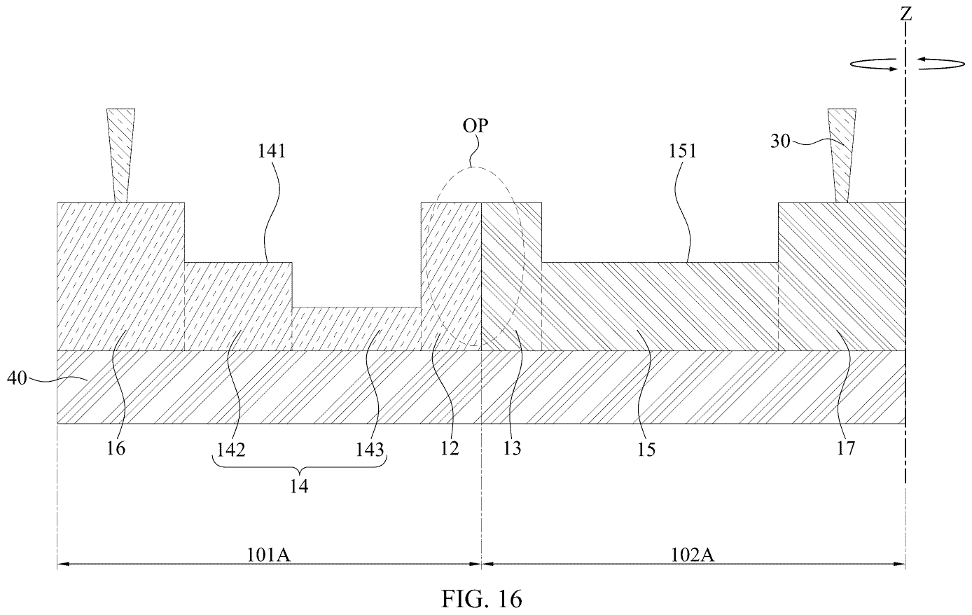

The optical coupling structure 10A illustrated in FIG. 15 is similar to that illustrated in FIG. 11, in which the configuration of the first slab region 14 is symmetric to that of the second slab region 15. In some another embodiments as shown in FIGS. 16 to 18, the configuration of the first slab region 14 is asymmetric to that of the second slab region 15.

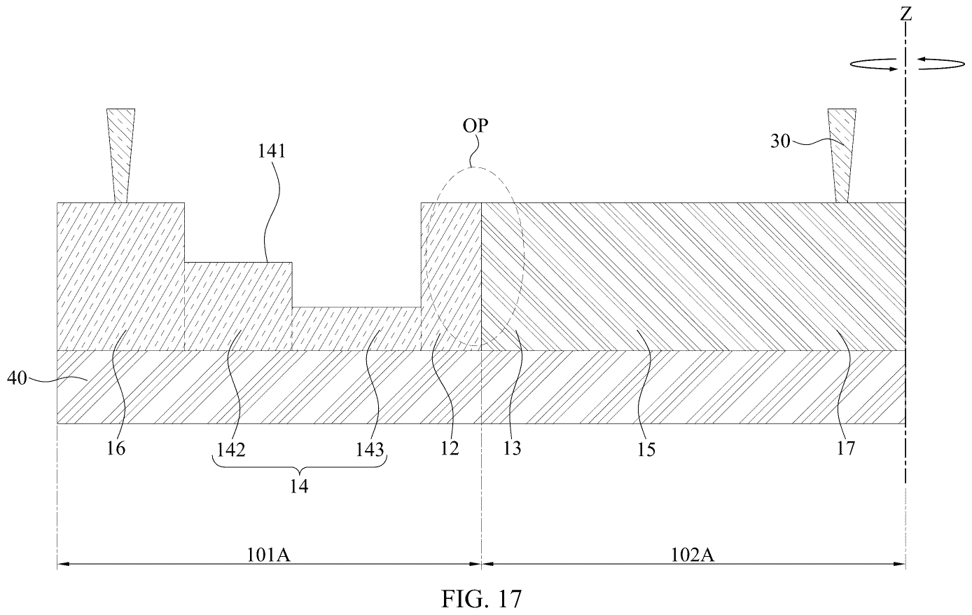

With reference to FIG. 16, the first slab region 14 has a stepwise top 141, so that the thickness of the first slab region 14 can be stepwisely decreased from an area near the first electrical coupling region 16 to an area near the first waveguide region 12 (along the second direction D2); and the second slab region 15 has a substantially flat top. The first slab region 14 comprises a first step portion 142 abutting the first electrical coupling region 16 and a second step portion 143 abutting the first waveguide region 12. The thickness of the first step portion 142 may be greater than the thickness of the second step portion 143. The thickness of the second slab region 15 may be greater than the thickness of the second step portion 143 of the first slab region 14 and may be substantially identical to or different from the thickness of the first step portion 142. As shown in FIG. 17, the thickness of the second slab region 15 may be substantially identical to the thickness of the second waveguide region 13 and may be substantially identical to the thickness of the second electrical coupling region 17, so the top of the second slab region 15 may be substantially flat and coplanar with the top of the second waveguide region 13 and the top of the second electrical coupling region 17.

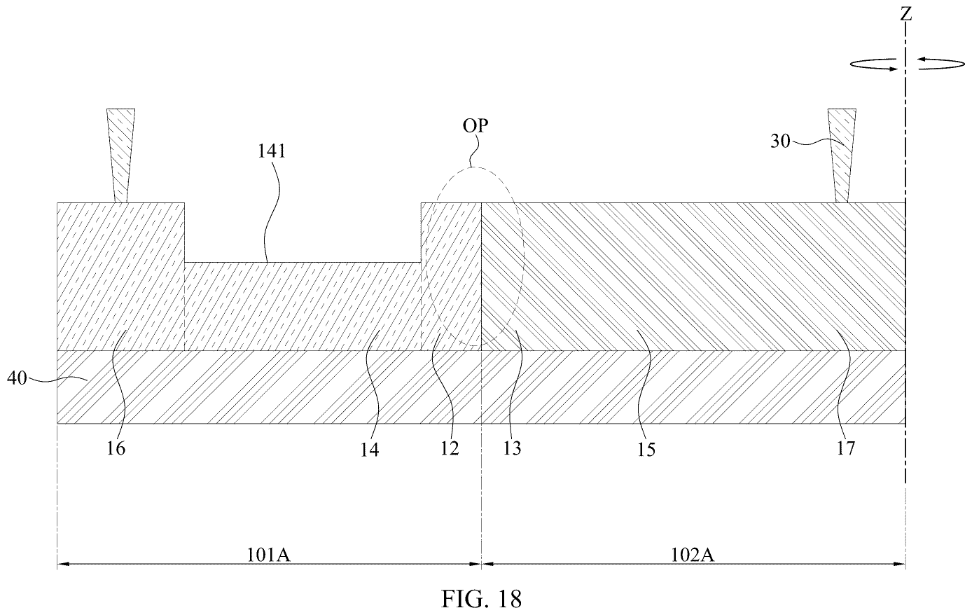

In some another embodiments as shown in FIG. 18, the first slab region 14 has a substantially flat top and the second slab region 15 also has a substantially flat top. The thickness of the second slab region 15 can be greater than the thickness of the first slab region 14. A ratio of the thickness of the first slab region 14 to the thickness of the second slab region 15 may range from about 1:10 to about 9:10. In some embodiments, the ratio of the thickness of the first slab region 14 to the thickness of the second slab region 15 may range from about 1:9 to about 7:10. In some embodiments, the ratio of the thickness of the first slab region 14 to the thickness of the second slab region 15 may range from about 1:7 to about 3:5. As shown in FIGS. 16 to 18, the slab region near the rotation center Z can have a thickness greater than a thickness of the slab region far away from the rotation center Z so as to reduce resistance. In some embodiments, one of or some of the first waveguide region 12, the second waveguide region 13, the first slab region 14, the second slab region 15, the first electrical coupling region 16 and the second electrical coupling region 17 may be undoped.

With varying thicknesses of the first and second slab regions 14, 15, the photonic structure in accordance with the present disclosure can offer improved optical mode confinement while simultaneously reducing parasitic resistance. Such reduction in parasitic resistance can further enhance the resistor-capacitor (RC) bandwidth of active devices.

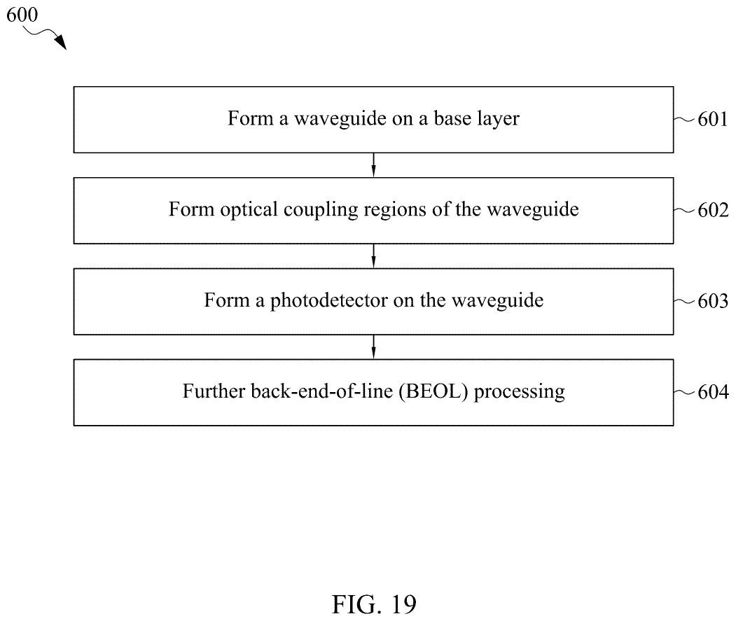

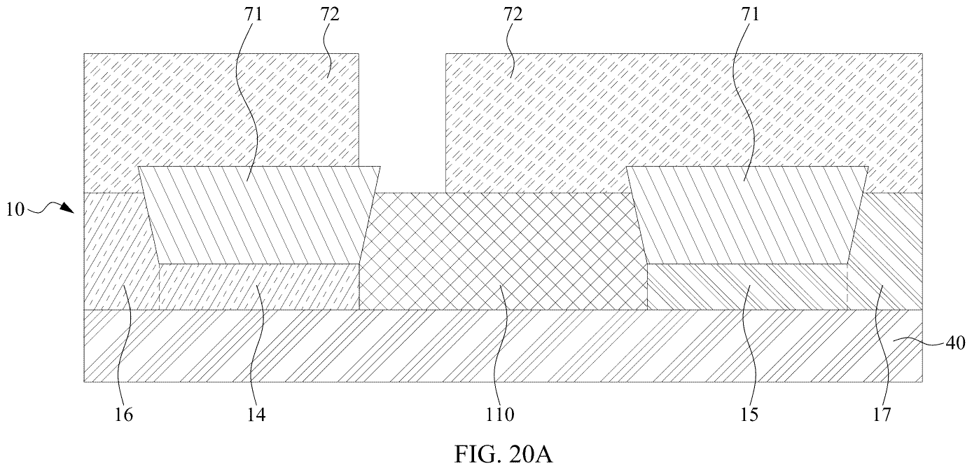

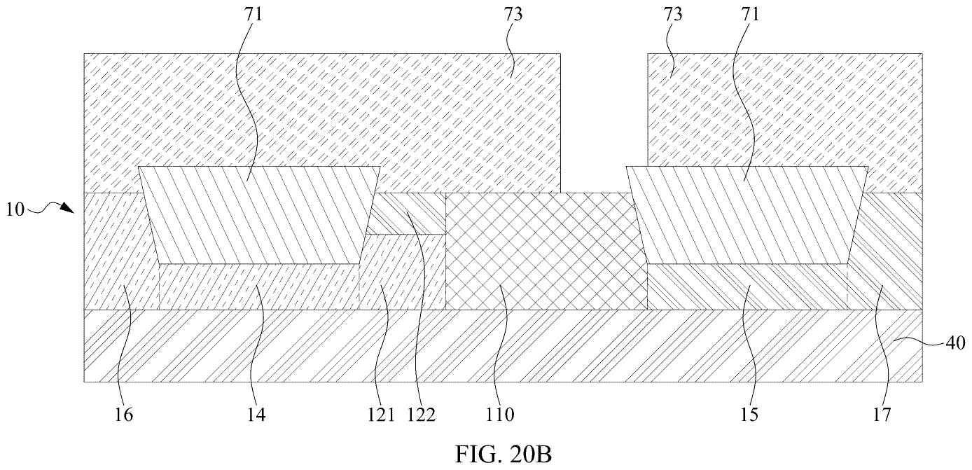

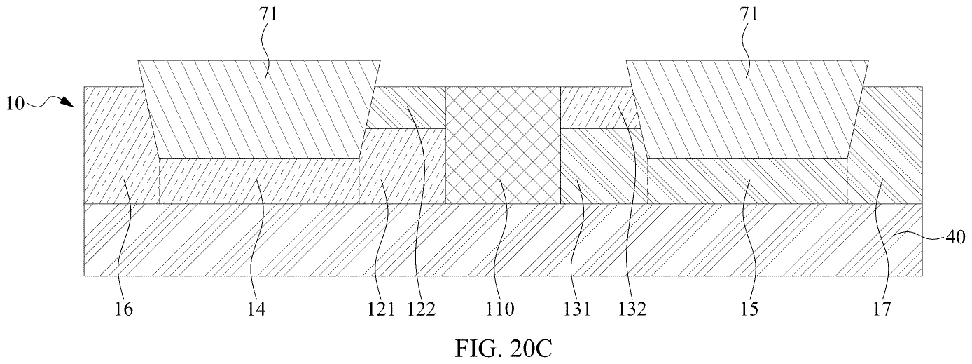

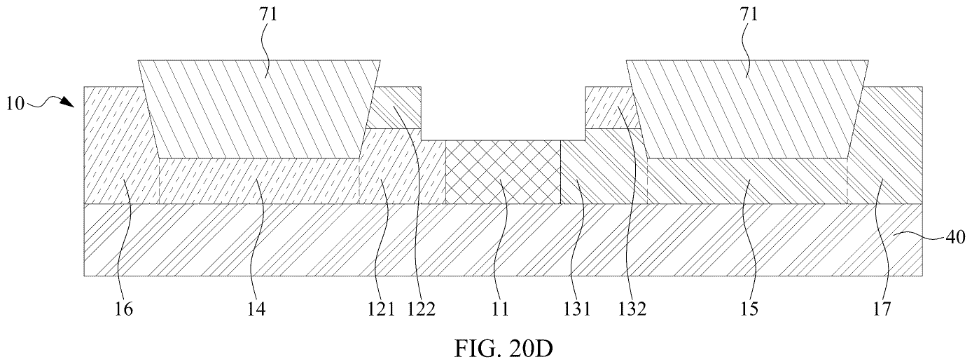

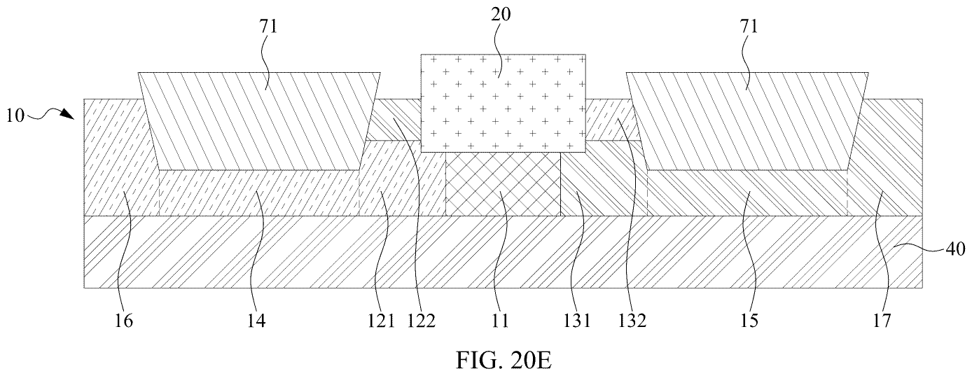

FIG. 19 is a flowchart representing a method 600 for forming a photonic structure including a photodetector according to various aspects of the present disclosure. In some embodiments, the method 600 for forming the photonic structure includes a number of operations (601, 602, 603 and 604). The method 600 for forming the photonic structure will be further described according to one or more embodiments. It should be noted that the operations of the method 600 may be rearranged or otherwise modified within the scope of the various aspects. It should further be noted that additional processes may be provided before, during, and after the method 600, and that some other processes may be only briefly described herein. The operations of the method 600 in FIG. 19, including any descriptions given with reference to FIGS. 20A to 20E, are merely exemplary and are not intended to be limiting beyond what is specifically recited in the claims that follow. FIGS. 20A to 20E are provided to illustrate the cross-sectional views corresponding to the cross-section along line A-A′ as shown in FIG. 1.

With reference to FIG. 20A, the method 600 begins at operation 601 where an optical coupling structure 10 with a base layer 40 is provided and received. The base layer 40 may comprise a substrate and a cladding layer. The substrate is usually a wafer made of a semiconducting material. Such materials can include silicon, for example in the form of crystalline Si or polycrystalline Si. The substrate can also be made from other elementary semiconductors such as germanium or Al₂O₃ (sapphire), or may include a compound semiconductor such as silicon carbide (SiC), gallium nitride (GaN), gallium arsenide (GaAs), indium arsenide (InAs), and indium phosphide (InP), or from other materials such as glass, a ceramic, or a dielectric material. The substrate can be planarized through a chemical mechanical polishing (CMP) procedure. The cladding layer can be formed over the substrate and may be made of an insulation material including an oxide, such as silicon oxide, a nitride, such as silicon nitride, the like, or a combination thereof, which may be formed by a chemical vapor deposition (CVD) process, such as high-density plasma CVD (HDP-CVD), flowable chemical vapor deposition (FCVD), the like, or a combination thereof. Other insulation materials formed by any acceptable process may be used. In some embodiments, the insulation material is silicon oxide formed by FCVD. The cladding layer may be a single layer or multiple layers. The cladding layer can be planarized through a chemical mechanical polishing (CMP) procedure.

The optical coupling structure 10 is formed by forming a waveguide layer (such as silicon) over the cladding layer of the base layer 40; patterning the waveguide layer to include a central portion 110, a first slab region 14, a first electrical coupling region 16, a second slab region 15 and a second electrical coupling region 17; and applying isolation materials onto the first slab region 14 and the second slab region 15 and between the central portion 110 and the first electrical coupling region 16 and between the central portion 110 and the second electrical coupling region 17 to forming shallow trench isolations 71. The central portion 110 is sandwiched by the first slab region 14 and the second slab region 15; the first slab region 14 is sandwiched by the central portion 110 and the first electrical coupling region 16; the second slab region 15 is sandwiched by the central portion 110 and the second electrical coupling region 17. The first slab region 14 and the first electrical coupling region 16 can be doped with dopants having a first conductive type; and the second slab region 15 and a second electrical coupling region 17 can be doped with dopants having a second conductive type.

The method 600 continues with operation 602 where waveguide regions of the optical coupling structure 10 are formed by performing implantations to portions of the central portion 110. As shown in FIG. 20A, a first hard mask 72 can be partially formed onto the central portion 110 to expose a top of first part of the central portion 110 abutting to the first slab region 14. With further reference to FIG. 20B, a lower portion of the first part of the central portion 110 is doped with dopants having either the first conductive type or the second conductive type to form a bottom portion 121 of a first waveguide region 12, and an upper portion of the first part of the central portion 110 is doped with dopants having either the first conductive type or the second conductive type to form a top portion 122 of the first waveguide region 12 according to demand. In some embodiments, the bottom portion 121 of the first waveguide region 12 is doped with dopants having the first conductive type while the top portion 122 of the first waveguide region 12 is doped with dopants having the second conductive type.

Also referring to FIG. 20B, after removing the first hard mask 72, a second hard mask 73 can be partially onto the central portion 110 to expose a top of a second part of the central portion 110 abutting to the second slab region 15. With further reference to FIG. 20C, a lower portion of the second part of the central portion 110 is doped with dopants having either the first conductive type or the second conductive type to form a bottom portion 131 of a second waveguide region 13, and an upper portion of the second part of the central portion 110 is doped with dopants having either the first conductive type or the second conductive type to form a top portion 132 of the second waveguide region 13 according to demand. In some embodiments, the bottom portion 131 of the second waveguide region 13 is doped with dopants having the second conductive type while the top portion 132 of the second waveguide region 13 is doped with dopants having the second conductive type.

Then, as shown in FIG. 20D, the second hard mask 73 is removed before etching the remaining central portion 110, the top portion 122 of the first waveguide region 12 and the top portion 132 of the second waveguide region 13 to form a base region 11 sandwiched by the first waveguide region 12 and the second waveguide region 13.

At operation 603 as shown in FIG. 20E, a photodetector 20 is formed on the base region 11, partially on the bottom portion 121 of the first waveguide region 12 and the bottom portion 131 of the second waveguide region 13 and sandwiched by the top portion 122 of the first waveguide region 12 and the top portion 132 of the second waveguide region 13.

At operation 604, further back-end-of-line (BEOL) processing can be performed including applying a further cladding layer over the optical coupling structure 10 and the photodetector 20; forming a silicide layer on the first electrical coupling region 16 and the second electrical coupling region 17; forming an interlayer dielectric layer/inter-metal dielectric layer (ILD/IMD layer) on the further cladding layer; and forming metal lines in the ILD/IMD layer. The ILD/IMD layer may be, for example, silicon dioxide, silicon nitride, a low κ dielectric, some other dielectric, or a multi-layer film comprising a combination of the foregoing. As used herein, a low-κ dielectric is a dielectric with a dielectric constant κ less than about 3.9. In some embodiments, the material for forming the ILD/IMD layer may be identical to the material for forming the cladding layer.

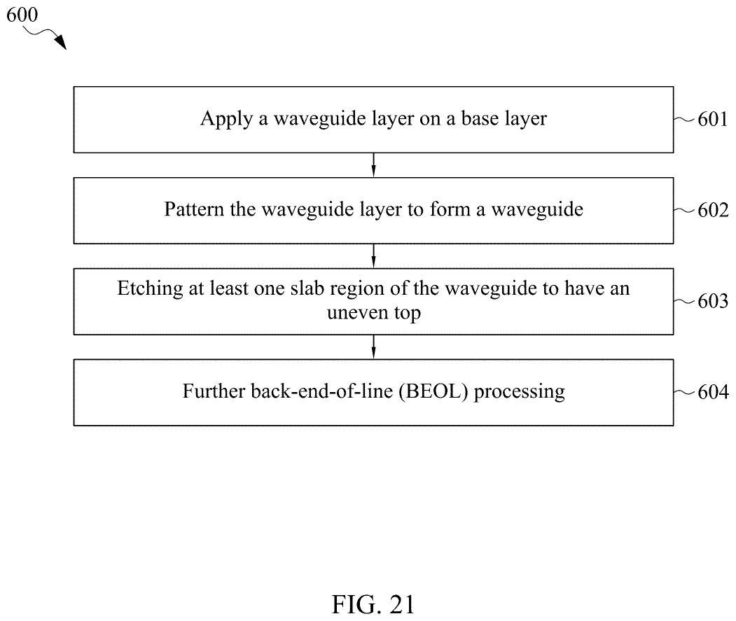

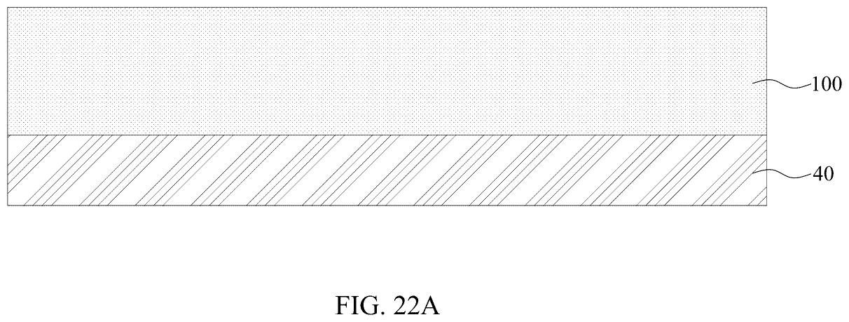

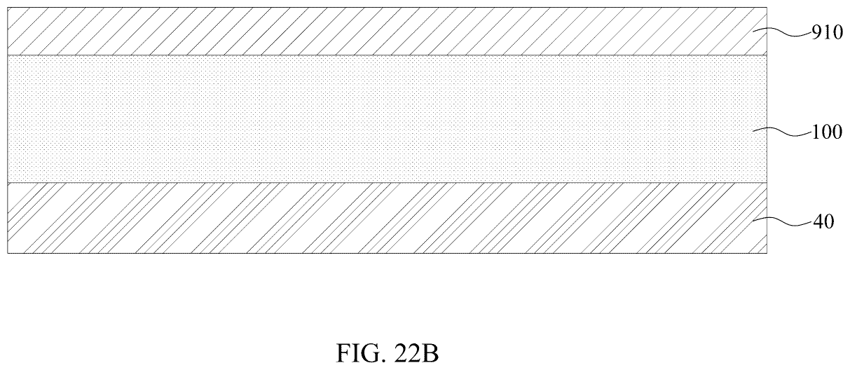

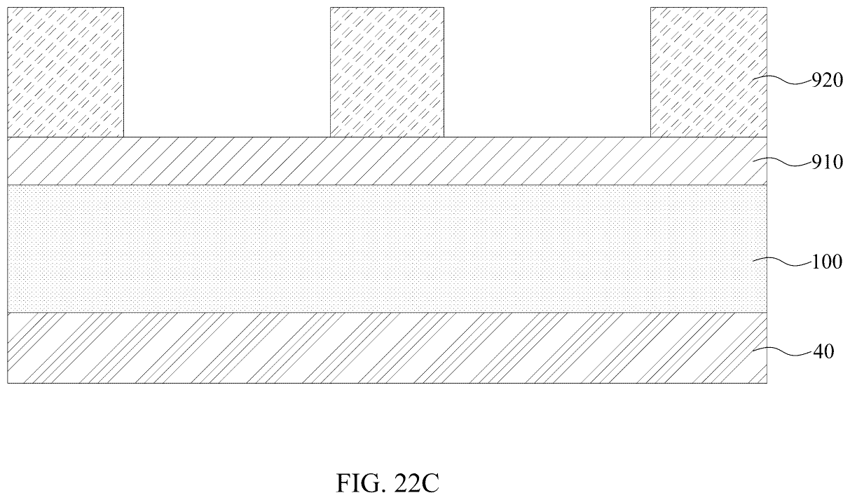

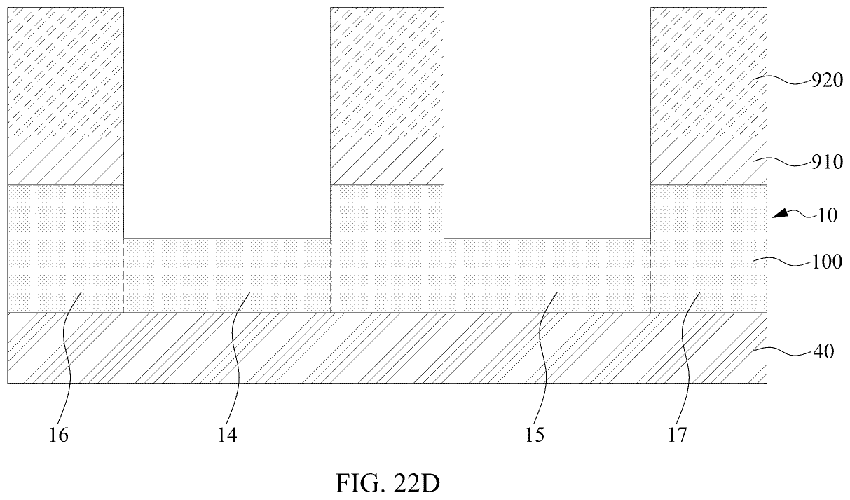

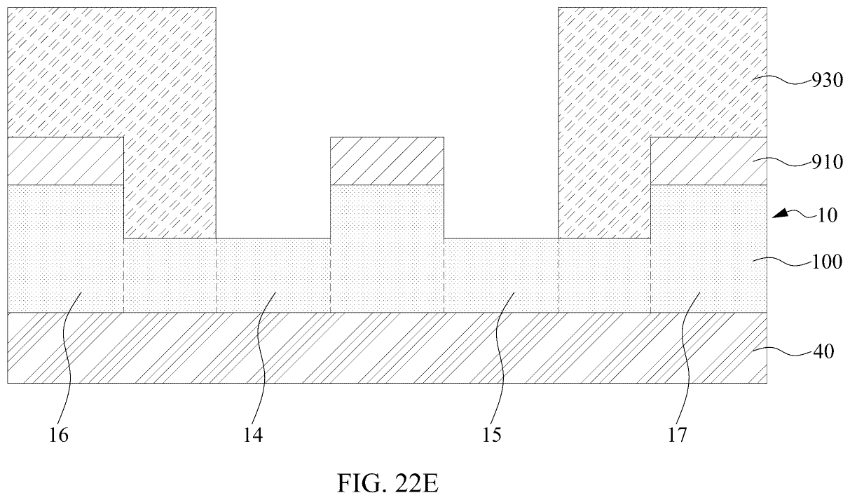

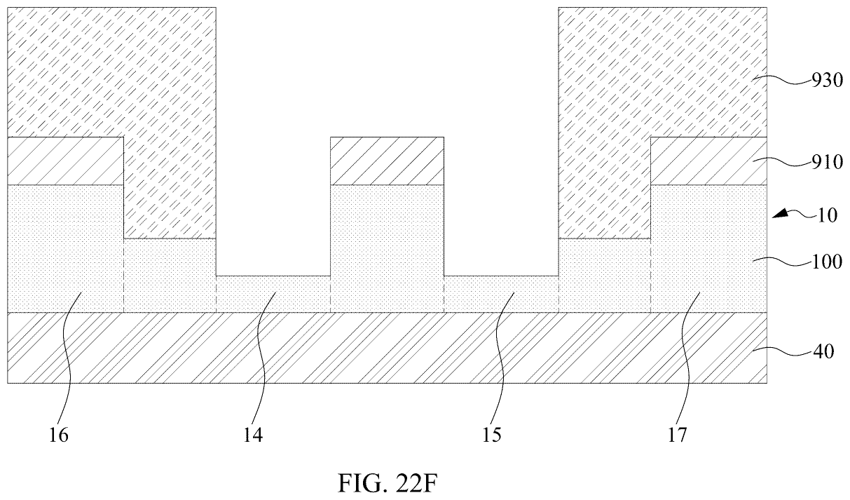

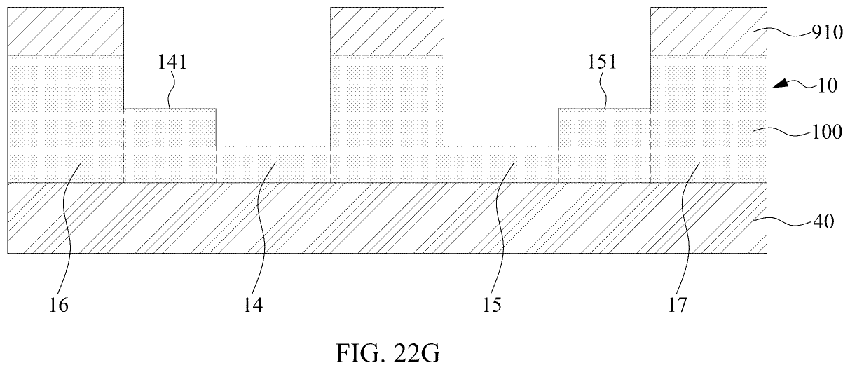

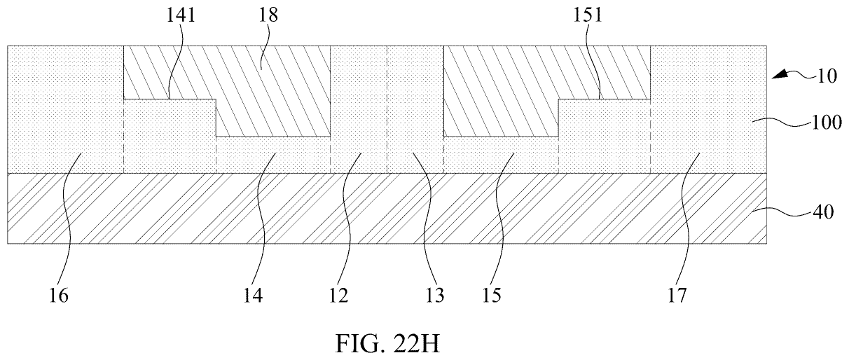

FIG. 21 is a flowchart representing a method 800 for forming a photonic structure without a photodetector according to various aspects of the present disclosure. In some embodiments, the method 800 for forming the photonic structure includes a number of operations (801, 802, 803 and 804). The method 800 for forming the photonic structure will be further described according to one or more embodiments. It should be noted that the operations of the method 800 may be rearranged or otherwise modified within the scope of the various aspects. It should further be noted that additional processes may be provided before, during, and after the method 800, and that some other processes may be only briefly described herein. The operations of the method 800 in FIG. 21, including any descriptions given with reference to FIGS. 22A to 22H, are merely exemplary and are not intended to be limiting beyond what is specifically recited in the claims that follow. FIGS. 22A to 22H are provided to illustrate the cross-sectional views corresponding to the cross-section along line B-B′ as shown in FIG. 9.

The method 800 begins at operation 801 where an optical coupling structure 10 with a base layer 40 is provided and received by forming a waveguide layer 100 on a base layer 40 including a substrate and a cladding layer as shown in FIG. 22A.

The method 800 continues with operation 802 where an optical coupling structure 10 is formed by patterning the waveguide layer 100, which comprises applying a first hard mask 910 on the waveguide layer 100 as shown in FIG. 22B; applying a first photoresist 920 on the first hard mask 910; and etching the waveguide layer 100 and the first hard mask 910 as shown in FIG. 22D, so that the optical coupling structure 10 include an waveguide region, a first slab region 14, a second slab region 15, a first electrical coupling region 16 and a second electrical coupling region 17. The waveguide region is sandwiched by the first slab region 14 and the second slab region 15; the first slab region 14 is sandwiched by the waveguide region and the first electrical coupling region 16; and the second slab region 15 is sandwiched by the waveguide region and the second electrical coupling region 17. A thickness of the first slab region 14 and a thickness of the second slab region 15 may be less than either one of thicknesses of the waveguide region, the first electrical coupling region 16 and the second electrical coupling region 17.

At operation 803, at least one slab region of the optical coupling structure 10 is etched to have a non-flat top. In some embodiments, one or more etching steps may be performed on the slab region of the optical coupling structure 10 to form a top in a staircase form. In some another embodiments, a single etching step using a mask with gradual transmission rate may be performed on the slab region of the optical coupling structure 10 to form a slope top. As shown in FIG. 22E, the first photoresist 920 can be removed before applying a second photoresist 930 on the first electrical coupling region 16 and the second electrical coupling region 17 and partially on the first slab region 14 and the second slab region 15 so as to expose an area of the first slab region 14 and an area of the second slab region 15 near the waveguide region. As shown in FIG. 22F, the exposed areas of the first slab region 14 and the second slab region 15 are etched to a deeper level so that, after removing the second photoresist 930, the first slab region 14 and the second slab region 15 have non-flat tops as shown in FIG. 22G.

As shown in FIG. 22H, a region of the waveguide region near the first slab region 14 the first slab region 14 and the first electrical coupling region 16 are doped with dopants having a first conductive type; and a region of the waveguide region near the second slab region 15, the second slab region 15 and the second electrical coupling region 17 are doped with dopants having a first conductive type, so that the waveguide region is divided into a first waveguide region 12 and a second waveguide region 13. Shallow trench isolation (STI) structures 18 may be formed on the first slab region 14 and the second slab region 15 and thus formed between the first waveguide region 12 and the first electrical coupling region 16 and between the second waveguide region 13 and the second electrical coupling region 17. The STI structures 18 may comprise oxides, such as silicon oxide and the like.

At operation 804, further back-end-of-line (BEOL) processing can be performed including applying a further cladding layer over the optical coupling structure 10; forming a silicide layer on the first electrical coupling region 16 and the second electrical coupling region 17; forming an interlayer dielectric layer/inter-metal dielectric layer (ILD/IMD layer) on the further cladding layer; and forming metal lines in the ILD/IMD layer. The ILD/IMD layer may be, for example, silicon dioxide, silicon nitride, a low κ dielectric, some other dielectric, or a multi-layer film comprising a combination of the foregoing. As used herein, a low-κ dielectric is a dielectric with a dielectric constant κ less than about 3.9. In some embodiments, the material for forming the ILD/IMD layer may be identical to the material for forming the cladding layer.

The photodetector 20 is configured to convert an incident radiation to an electric signal. The electric signal may, for example, result from electron-hole pairs generated in response to the photons of the incident radiation. The hybrid optical coupling structure 10 comprises the first waveguide region 12 and the second waveguide region 13 with different conductive type dopants, which serve as a lateral junction, and also comprises different conductive type dopants in the first waveguide region 12, the second waveguide region 13 or both, which serve as a vertical junction. Therefore, the hybrid optical coupling structure 10 in accordance with the present disclosure generates a uniform electric field, which improves efficiency and reduce screening effect. In addition, by varying the thickness of the slab region, the performance of the optical coupling structure 10 can be further enhanced. A thick portion of a slab region yields low resistance while a thin portion ensures good optical mode confinement, so such hybrid slab region can be implemented in straight waveguides, such as phase shifters, Mach-Zehnder modulators and bent waveguides, such as microring modulators.

In some embodiments, a photonic structure comprises an optical coupling structure comprising: a central portion including a first waveguide region and a second waveguide region; a first slab region extending from the first waveguide region along a first direction; a second slab region extending from the second waveguide region along a second direction opposite to the first direction; a first electrical coupling region extending from the first slab region along the first direction; and a second electrical coupling region extending from the second slab region along the second direction, wherein the first waveguide region, the second waveguide region, the first slab region, the second slab region, the first electrical coupling region and the second electrical coupling region are strips parallel to each other, wherein the first slab region and the first electrical coupling region have first dopants with a first conductivity type, and the second slab region and the second electrical coupling region have second dopants with a second conductivity type; and wherein at least one of the first waveguide region and the second waveguide region comprises two portions having dopants with different conductivity types.

In some embodiments, a photonic structure comprises a first waveguide region; a second waveguide region abutting the first waveguide region; a first slab region extending from the first waveguide region along a first direction; a second slab region extending from the second waveguide region along a second direction opposite to the first direction; a first electrical coupling region extending from the first slab region along the first direction; and a second electrical coupling region extending from the second slab region along the second direction, wherein the first waveguide region, the second waveguide region, the first slab region, the second slab region, the first electrical coupling region and the second electrical coupling region are strips parallel to each other, wherein the first waveguide region, the first slab region and the first electrical coupling region have first dopants with a first conductivity type, and the second waveguide region, the second slab region and the second electrical coupling region have second dopants with a second conductivity type, and wherein at least one of the first slab region and the second slab region has a non-flat top, so that a thickness of the at least one of the first slab region and the second slab region is gradually decreased from an area near an adjacent electrical coupling region to an area near an adjacent waveguide region.

In some embodiments, a method for forming a photonic structure comprises forming an optical coupling structure over a base layer, the optical coupling structure comprising: a central portion; a first slab region extending from the central portion along a first direction; a second slab region extending from the central portion along a second direction opposite to the first direction; a first electrical coupling region extending from the first slab region along the first direction; and a second electrical coupling region extending from the second slab region along the second direction; applying a first hard mask onto the central portion to expose a top of first part of the central portion abutting to the first slab region; doping a lower portion of the first part of the central portion with dopants having either a first conductive type or a second conductive type to form a bottom portion of a first waveguide region and doping an upper portion of the first part of the central portion with dopants having a conductive type different from the conductive type of the bottom portion of the first waveguide region so as to form a top portion of the first waveguide region; removing the first hard mask and applying a second hard mask onto the central portion to expose a top of a second part of the central portion abutting to the second slab region; doping the second part of the central portion with dopants having the first conductive type, the second conductive type or both to form a second waveguide region; and removing the second hard mask.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A photonic structure, comprising:
an optical coupling structure comprising:
a central portion including a first waveguide region and a second waveguide region;
a first slab region extending from the first waveguide region along a first direction;
a second slab region extending from the second waveguide region along a second direction opposite to the first direction;
a first electrical coupling region extending from the first slab region along the first direction; and
a second electrical coupling region extending from the second slab region along the second direction,
wherein the first waveguide region, the second waveguide region, the first slab region, the second slab region, the first electrical coupling region and the second electrical coupling region are strips parallel to each other,
wherein the first slab region and the first electrical coupling region have first dopants with a first conductivity type, and the second slab region and the second electrical coupling region have second dopants with a second conductivity type; and
wherein at least one of the first waveguide region and the second waveguide region comprises two portions having dopants with different conductivity types.

2. The photonic structure of claim 1,
wherein the central portion comprises a base region sandwiched by the first waveguide region and the second waveguide region;
wherein the photonic structure further comprises a photodetector formed on the base region of the optical coupling structure and between the first waveguide region and the second waveguide region;
wherein the first waveguide region comprises a bottom portion having the first dopants and a top portion having the second dopants;
wherein the second waveguide region comprises a bottom portion having the second dopants and a top portion having the first dopants; and
wherein the base region of the optical coupling structure is sandwiched by the bottom portion of the first waveguide region and the bottom portion of the second waveguide region, and
wherein the top portion of the first waveguide region and the top portion of the second waveguide region abut the photodetector.

3. The photonic structure of claim 2, wherein a ratio of a thickness of the bottom portion of the
first waveguide region to a thickness of the first waveguide region ranges from about 0.1:1 to about 0.9:1.

4. The photonic structure of claim 1, wherein
one of the first waveguide region and the second waveguide region comprises a bottom portion having dopants with a conductivity type identical to the conductivity type of an adjacent slab region, and a top portion having dopants with a conductivity type different from the conductivity type of the bottom portion; and
an other one of the first waveguide region and the second waveguide region has dopants with a conductivity type identical to or different from the conductivity type of an adjacent slab region.

5. The photonic structure of claim 1, wherein
the first waveguide region comprises an outer portion having the first dopants and an inner portion having the second dopants; and
the second waveguide region comprises an outer portion having the second dopants and an inner portion having the first dopants,
wherein the central portion further comprises a base region sandwiched by the outer portion of the first waveguide region and the outer portion of the second waveguide region, and
wherein the inner portion of the first waveguide region is surrounded by the outer portion of the first waveguide region to expose a top of the inner portion of the first waveguide region, and the inner portion of the second waveguide region is surrounded by the outer portion of the second waveguide region to expose a top of the inner portion of the second waveguide region.

6. The photonic structure of claim 1, wherein
one of the first waveguide region and the second waveguide region comprises an outer portion having dopants with a conductivity type identical to the conductivity type of an adjacent slab region, and an inner portion having dopants with a conductivity type different from the conductivity type of the outer portion; and
another one of the first waveguide region and the second waveguide region has dopants with a conductivity type identical to or different from the conductivity type of an adjacent slab region, and
wherein the inner portion is surrounded by the outer portion to expose a top of the inner portion.

7. The photonic structure of claim 1, wherein
the first slab region has a non-flat top, so that a thickness of the first slab region is gradually decreased from an area near the first electrical coupling region to an area near the first waveguide region; and
the second slab region has a non-flat top, so that a thickness of the second slab region is gradually decreased from an area near the second electrical coupling region to an area near the second waveguide region.

8. The photonic structure of claim 7, wherein the first slab region has a stepwise or slope top and the second slab region has a stepwise or slope top.

9. A photonic structure, comprising:
a first waveguide region;
a second waveguide region abutting the first waveguide region;
a first slab region extending from the first waveguide region along a first direction;
a second slab region extending from the second waveguide region along a second direction opposite to the first direction;
a first electrical coupling region extending from the first slab region along the first direction; and
a second electrical coupling region extending from the second slab region along the second direction,
wherein the first waveguide region, the second waveguide region, the first slab region, the second slab region, the first electrical coupling region and the second electrical coupling region are strips parallel to each other,
wherein the first waveguide region, the first slab region and the first electrical coupling region have first dopants with a first conductivity type, and the second waveguide region, the second slab region and the second electrical coupling region have second dopants with a second conductivity type, and
wherein at least one of the first slab region and the second slab region has a non-flat top, so that a thickness of the at least one of the first slab region and the second slab region is gradually decreased from an area near an adjacent electrical coupling region to an area near an adjacent waveguide region.

10. The photonic structure of claim 9, wherein the at least one of the first slab region and the second slab region has a stepwise top or a slop top.

11. The photonic structure of claim 9, wherein
the first slab region comprises a first step portion abutting the first electrical coupling region and a second step portion abutting the first waveguide region, wherein a thickness of the first electrical coupling region is greater than a thickness of the first step portion of the first slab region; and the thickness of the first step portion of the first slab region is greater than a thickness of the second step portion of the first slab region; and
the second slab region comprises a first step portion abutting the second electrical coupling region and a second step portion abutting the second waveguide region, wherein a thickness of the second electrical coupling region is greater than a thickness of the first step portion of the second slab region; and the thickness of the first step portion of the second slab region is greater than a thickness of the second step portion of the second slab region.

12. The photonic structure of claim 11, wherein
a ratio of the thickness of the first step portion of the first slab region to the thickness of the first electrical coupling region ranges from about 1:2 to about 1:50; and a ratio of the thickness of the second step portion of the first slab region to the thickness of the first electrical coupling region may range from about 1:3 to about 1:50; and
a ratio of the thickness of the first step portion of the second slab region to the thickness of the second electrical coupling region ranges from about 1:2 to about 1:50; and a ratio of the thickness of the second step portion of the second slab region to the thickness of the second electrical coupling region may range from about 1:3 to about 1:50.

13. The photonic structure of claim 9, wherein the first slab region has a non-flat top and the second slab region has a flat top.

14. The photonic structure of claim 9, wherein the first waveguide region and the second waveguide region are curved; and the first slab region has a front cross-section, which is symmetric or asymmetric to a front cross-section of the second slab region.

15. The photonic structure of claim 14, wherein the optical coupling structure comprises an
outer region and an inner region with a rotation center,
wherein the outer region far away from the rotation center comprises the first waveguide region, the first slab region and the first electrical coupling region; and the inner region near the rotation center comprises the second waveguide region, the second slab region and the second electrical coupling region, and
wherein the second slab region has a thickness greater than a thickness of the first slab region.

16. A method for manufacturing a photonic structure, comprising:
forming an optical coupling structure over a base layer, the optical coupling structure comprising:
a central portion;
a first slab region extending from the central portion along a first direction;
a second slab region extending from the central portion along a second direction opposite to the first direction;
a first electrical coupling region extending from the first slab region along the first direction; and
a second electrical coupling region extending from the second slab region along the second direction;
applying a first hard mask onto the central portion to expose a top of a first part of the central portion abutting to the first slab region;
doping a lower portion of the first part of the central portion with dopants having either a first conductive type or a second conductive type to form a bottom portion of a waveguide region and doping an upper portion of the first part of the central portion with dopants having a conductive type different from the conductive type of the bottom portion of the waveguide region so as to form a top portion of the waveguide region;
removing the first hard mask and applying a second hard mask onto the central portion to expose a top of a second part of the central portion abutting to the second slab region;
doping the second part of the central portion with dopants having the first conductive type, the second conductive type or both to form a second waveguide region; and
removing the second hard mask.

17. The method of claim 16, wherein doping the second part of the central portion comprises doping a lower portion of the second part of the central portion with dopants having either a first conductive type or a second conductive type to form a bottom portion of the second waveguide region and doping an upper portion of the second part of the central portion with dopants having a conductive type different from the conductive type of the bottom portion of the second waveguide region so as to form a top portion of the second waveguide region.

18. The method of claim 16, wherein before applying the first hard mask, the first slab region and the first electrical coupling region are doped with dopants having the first conductive type; and the second slab region and the second electrical coupling region are doped with dopants having the second conductive type.

19. The method of claim 16, further comprising forming a photodetector on the central portion and between the first optical coupling region and the second optical coupling region of the optical coupling structure, wherein before forming the photodetector on the central portion of the optical coupling structure, the central portion is etched to reduce a thickness and the waveguide region and the second waveguide region are partially etched for holding the optical coupling structure.

20. The method of claim 16, forming a photodetector on the central portion and between the first optical coupling region and the second optical coupling region of the optical coupling structure wherein before forming the photodetector, at least one of the first slab region and the second slab region is etched to form a non-flat top.
